(19) United States
(12) Patent Application Publication
(10) Pub. No.: US 2014/0097051 A1
(43) Pub. Date: Apr. 10, 2014

(54) BICYCLE BRAKE DISC ASSEMBLY

(71) Applicant: Wayne-Ian Moore, Changhua County (TW)

(72) Inventor: Wayne-Ian Moore, Changhua County (TW)

(21) Appl. No.: 13/909,096

(22) Filed: Jun. 4, 2013

(30) Foreign Application Priority Data
Oct. 9, 2012 (TW) 101137333

(51) Int. Cl. F16D 65/12

(52) U.S. Cl. CPC F16D 65/123
USPC 188/218 XL

(57) ABSTRACT

A bicycle brake disc assembly includes an inner disc, an outer annular disc and a plurality of joint assemblies. The outer annular disc encloses the inner disc. The outer annular disc has a plurality of attachment arms. The inner disc has a plurality of connecting arms. The joint assemblies connect the attachment arms and the connecting arms. Each joint member has a first joint member and a second joint member. The first joint member and the second joint member are riveted together. A buffer groove defined between the first joint member and the second joint member. Each attachment arm and each connecting arm are clipped within the buffer groove. Under this arrangement, the inner disc and the outer annular disc are movable in the buffer groove during baking.

### BACKGROUND OF THE INVENTION

1. Field of the Invention

The present invention relates to a brake disc, and more particularly to a floating type brake disc assembly with flat surface for a bicycle.

2. Description of Related Art

Bicycle activity is becoming an increasingly popular recreation as well as a means of transportation. Moreover, bicycle activity has become a very popular competitive sport. Because a brake system for a bicycle is very important for ensuring the safety of riders, the improvement of the brake system is continuously progressed.

There are several types of bicycle brake devices, which are currently available on the market. The three main types of bicycle devices are: rim brakes, disc brakes, and drum brakes. If a rider wants a very high performance brake system, then the rider typically wants a disc brake system. Disc brake systems provide a substantial braking power in relationship to the amount of braking force applied to the brake lever. In addition, a floating type disc brake is widely used in the disc brake system so as to prevent a brake disc of the disc brake system from being deformed.

A conventional floating type brake disc comprises an inner disc, an outer disc and a plurality of connecting assemblies. The connecting assemblies connect the inner disc and the outer disc by means of riveting. Each connecting assembly has a connecting member, a washer and an elastomer. The connecting member has a flange, a post and a pin. The flange is defined at one end thereof. The post is protruded from one end of the flange and the pin is further protruded from one end of the post. The post is longer than a thickness of the brake disc. The pin of the connecting member is connected with the washer by means of riveting. The elastomer is mounted between the washer and the brake disc. Therefore, the inner disc and the outer disc are coupled with each other by the connecting assemblies and the outer disc could be slightly movable relative to the inner disc so as to prevent the brake disc from being deformed by a lateral force during braking.

However, the conventional floating type brake disc has a disadvantage as following.

The pin of the connecting member is directly protruded from an outer surface of the washer; therefore, the surface of the brake disc is rough and the protruding portion is easily destroyed.

The present invention has arisen to mitigate and/or obviate the disadvantages of the conventional brake disc.

### SUMMARY OF THE INVENTION

The main objective of the present invention is to provide an improved bicycle brake disc.

To achieve the objective, a bicycle brake disc assembly comprises an inner disc having a plurality of attachment arms radially extending from an outer periphery thereof, each of the attachment arms having a first connecting recess defined at a terminal end thereof; an outer annular disc enclosing the inner disc, the outer annular disc having a plurality of connecting arms extending from an inner periphery thereof toward the inner disc, each of the connecting arms having a second connecting recess defined at a terminal end thereof, the first connecting recess and the second connecting recess defining a connecting hole; a plurality of joint assemblies assembled in the connecting hole, each joint assembly having a first joint member and a second joint member, the first joint member having a first flange defined at one end thereof and a first cylindrical post protruded from one side of the first flange, the first joint member having a through hole opened therethrough, the second joint member having a second flange defined at one end thereof and a second cylindrical post protruded from one side of the second flange, the second cylindrical post having a bending portion defined at a terminal end thereof, the second cylindrical post passing through the through hole of the first joint member, a buffer groove defined between the first flange and the second flange, the terminal end of each attachment arm and the terminal end of each connecting arm clipped in the buffer groove so that the inner disc and the outer annular disc are movable within the buffer groove of each joint assembly. Wherein the first joint member of each joint assembly has a shoulder defined in an inner periphery of the through hole; the bending portion of the second joint member passes through the through hole and is further bent toward the shoulder and abutted against the shoulder; the connecting hole has a large aperture and a small aperture defined therein, the large aperture communicating with the small aperture; the first cylindrical post of the first joint member passes through the small aperture and the first flange is positioned in the large aperture; a washer mounted around the first cylindrical post of the first joint member; one side of the washer abuts against each attachment arm and each connecting arm; another side of the washer abuts against an inner side of the second flange of the second joint member.

Further benefits and advantages of the present invention will become apparent after a careful reading of the detailed description with appropriate reference to the accompanying drawings.

### BRIEF DESCRIPTION OF THE DRAWINGS

FIG. 1 is a side view of a bicycle brake disc assembly in accordance with the present invention;

FIG. 2 is a partially exploded perspective view of FIG. 1;

FIG. 3 is a perspective view of a connecting hole which is defined by an attachment arm and a connecting arm;

FIG. 4 is a partially perspective view showing a joint assembly mounted in the connecting hole of FIG. 2;

FIG. 5 is a partially perspective view for showing another side of FIG. 4;

FIG. 6 is a cross-sectional exploded view of FIG. 2; and

FIG. 7 is a cross-sectional view of FIG. 4.

### DETAILED DESCRIPTION OF THE INVENTION

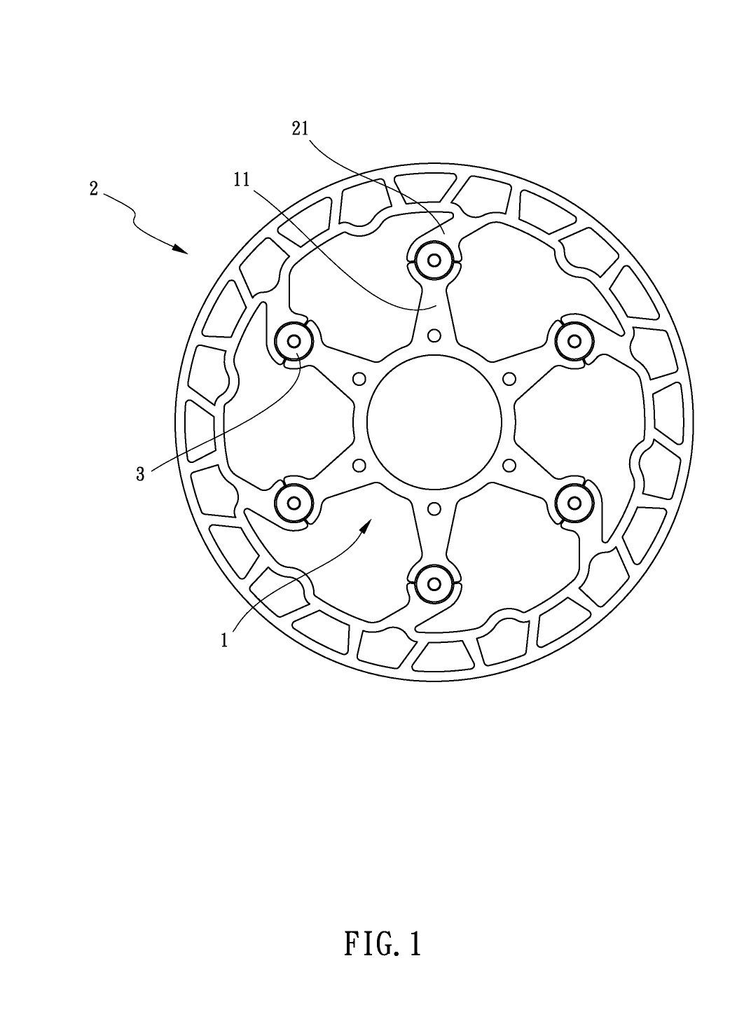

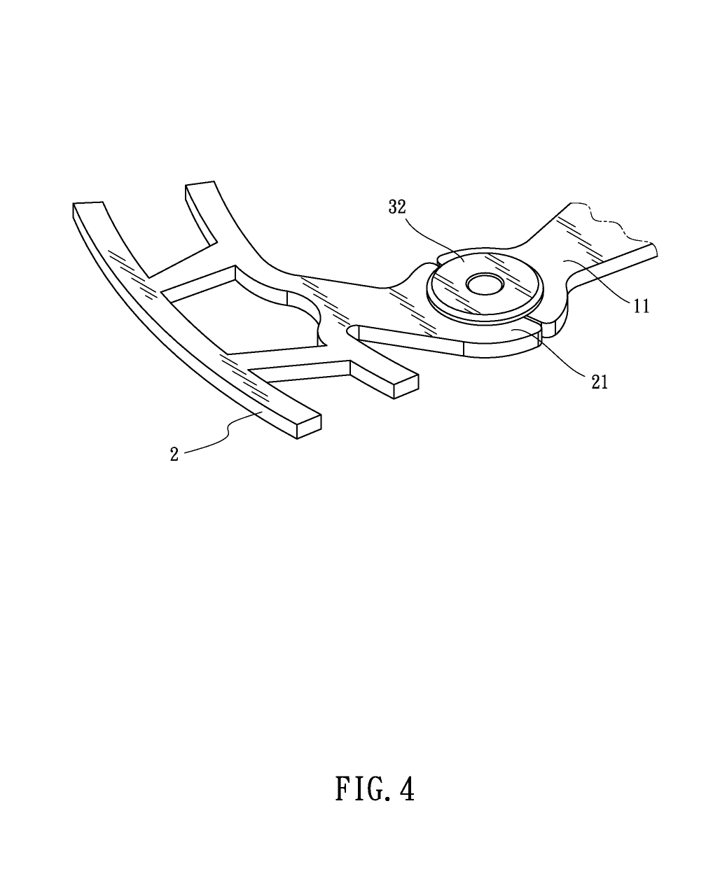

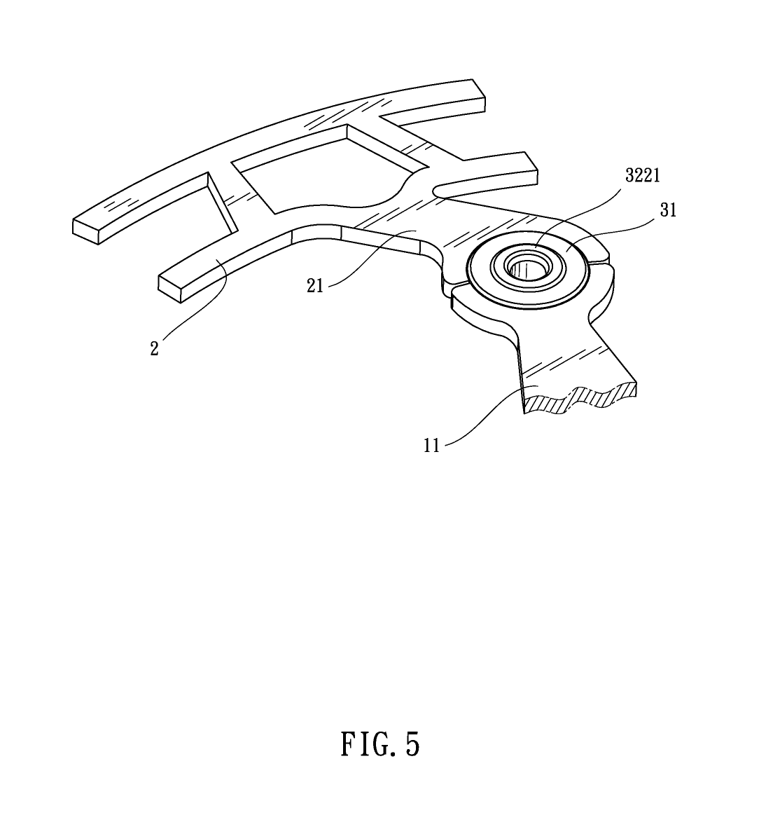

Referring to FIGS. 1-7, a bicycle brake disc assembly in accordance with the present invention comprises an inner disc 1, an outer annular disc 2 enclosing the inner disc 1 and a plurality of joint assemblies 3.

The inner disc 1 has a plurality of attachment arms 11 radially extending from an outer periphery of the inner disc 1 toward the outer annular disc 2. Each of the attachment arms 11 has a first connecting recess 111 defined at a terminal end thereof.

The outer annular disc 2 has a plurality of connecting arms 21 extending from an inner periphery thereof toward the inner disc 1. Each of the connecting arms 21 has a second connecting recess 211 defined at a terminal end thereof. The first connecting recess 111 of each attachment arm 11 and the second connecting recess 211 of each corresponding connecting arm 21 define a connecting hole 4.

Each of the joint assemblies 3 is assembled in the connecting hole 4 so as to position the inner disc 1 in the outer annular disc 2. Each joint assembly 3 has a first joint member 31 and a second joint member 32. The first joint member 31 has a first flange 311 defined at one end thereof and a first cylindrical post 312 defined at another end thereof. The first cylindrical post 312 is protruded from one side of the first flange 311. The first joint member 31 has a through hole 313 opened through the first cylindrical post 312 and the first flange 311. The second joint member 32 has a second flange 321 defined at one end thereof and a second cylindrical post 322 defined at another end thereof. The second cylindrical post 322 is protruded from one side of the second flange 321. The second cylindrical post 322 has a bending portion 3221 defined at a terminal end thereof which is opposite to the second flange 321. The second cylindrical post 322 of the second joint member 32 passes through the through hole 313 of the first joint member 31 from the first cylindrical post 312 to the first flange 311 so as to be positioned in the first joint member 31. A buffer groove 33 is defined between the first flange 311 and the second flange 321. The terminal end of each attachment arm 11 and the terminal end of each connecting arm 21 are clipped in the buffer groove 33. A width of the buffer groove 33 is slightly larger than a thickness of the terminal end of each attachment arm 11 and another thickness of the terminal end of each connecting arm 21.

Under this arrangement, the inner disc 1 and the outer annular disc 2 are movable within the buffer groove 33 of each joint assembly 3 during baking so as to prevent the inner disc 2 or the outer annular disc 1 from being deformed by an external force.

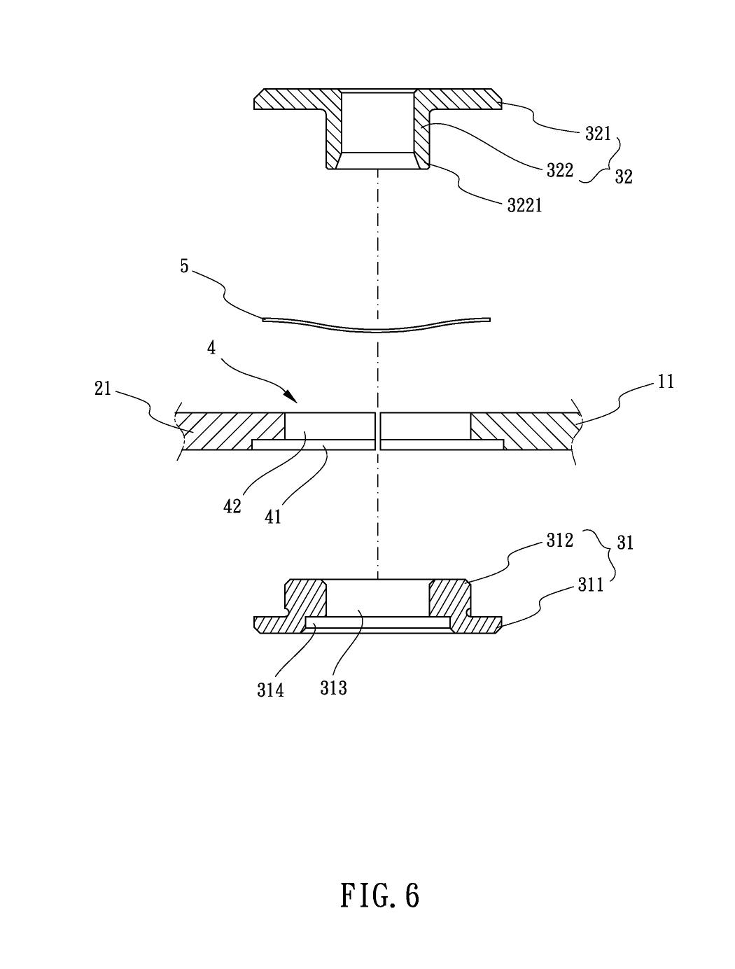

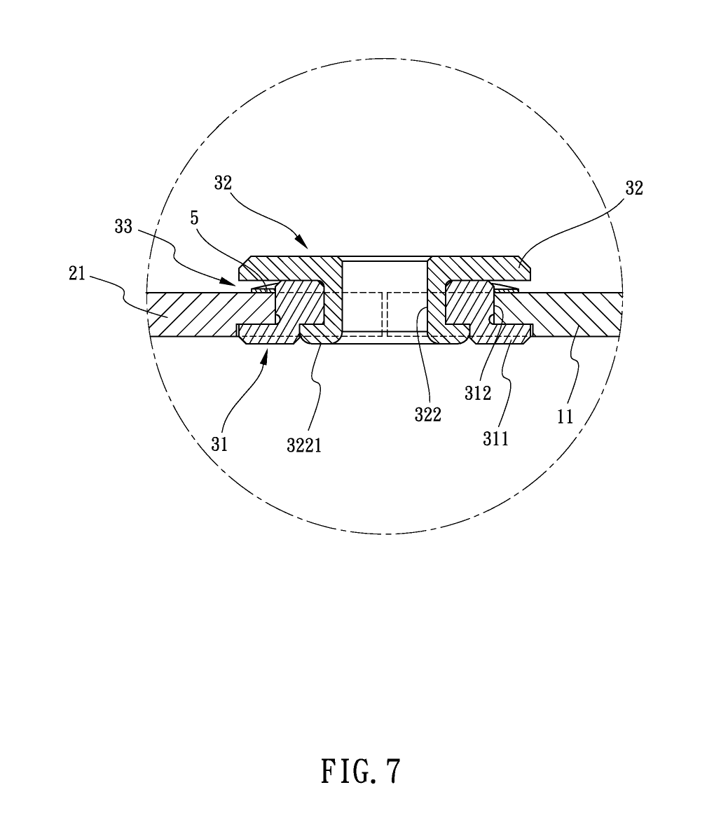

Referring to FIGS. 6-7, an assembling process is described as following.

Firstly, the terminal end of each attachment arm 11 and the terminal end of each corresponding connecting arm 21 are coupled to an outer periphery of the first cylindrical post 312 of the first joint member 31 (as shown in FIG. 6). Secondly, the second cylindrical post 322 of the second joint member 32 passes through the through hole 313 of the first joint member 31. Finally, each attachment arm 11 and each corresponding connecting arm 21 are clipped within the buffer groove 33 which is defined between the first flange 311 and the second flange 321, wherein a thickness of the terminal end of each attachment arm 11 and another terminal end of each connecting arm 21 are smaller than the width of the buffer groove 33.

Therefore, the inner disc 1 and the outer annular disc 2 are coupled with each other via the first joint member 31 and the second joint member 32, so that the inner disc 1 and the outer annular disc 2 are movable within the buffer groove 33. Furthermore, the buffer groove 33 provides a buffer effect against the external force during braking so as to prevent the inner disc 2 or the outer annular disc 1 from being deformed.

Referring to FIGS. 6-7, the first joint member 31 of each joint assembly 3 has a shoulder 314 defined in an inner periphery of the through hole 313, so that the through hole 313 reduces inwardly and forms a stepped structure (as shown in FIG. 6). After, the bending portion 3221 of the second joint member 32 passes through the through hole 313 from the first cylindrical post 312 to the first flange 311 and the bending portion 3221 is exposed from the shoulder 314, the bending portion 3221 of the second joint member 32 is further bent toward the shoulder 314 and abutted against the shoulder 314 so that the bending portion 3221 is not protruded from through hole 313. Therefore, a bottom surface of the first joint member 32 is flat; the first joint member 31 and the second joint member 32 are coupled together by means of riveting so that the inner disc 1 is coupled with the outer annular disc 2 via the joint assemblies 3.

Referring to FIG. 3, the connecting hole 4 which is formed by each attachment arm 11 and each connecting arm 21 has a large aperture 41 and a small aperture 42 defined therein. The large aperture 41 communicates with the small aperture 42 so that the connecting hole 4 is formed as a stair shape. The first cylindrical post 312 of the first joint member 31 passes through the small aperture 42 and the first flange 311 is positioned in the large aperture 41. Therefore, the first joint member 31 of each joint assembly 3 is received in the connecting hole 4 so that a lateral surface of the whole brake disk is flat.

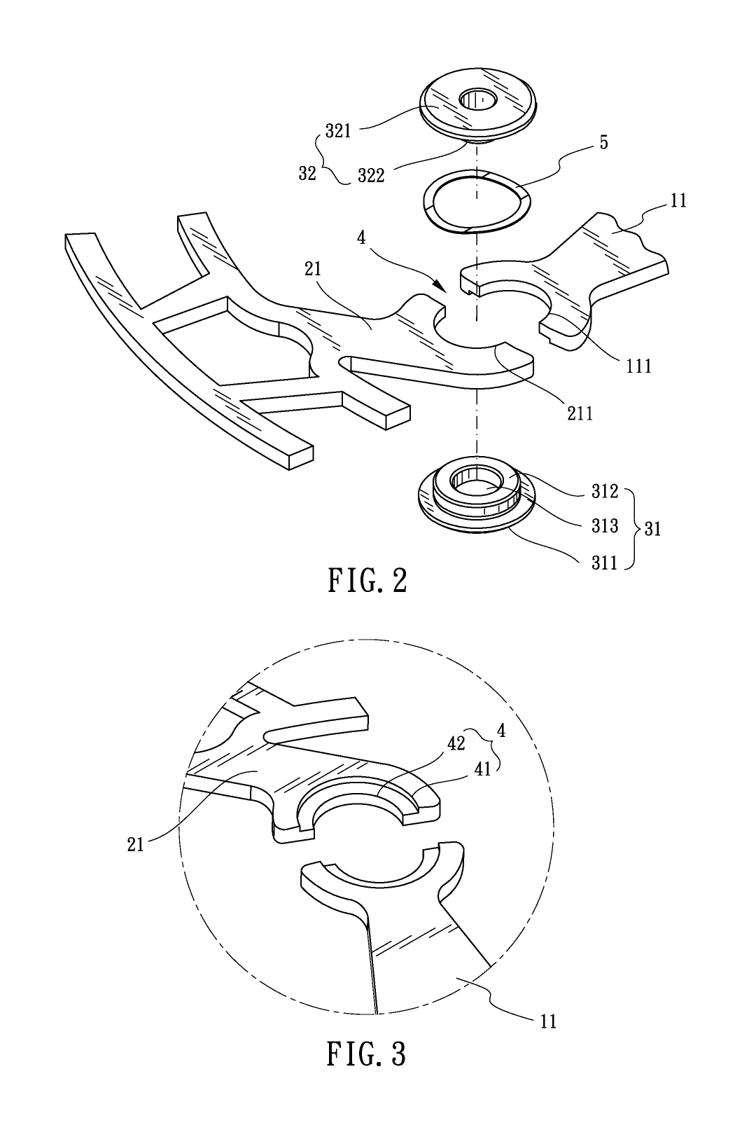

Furthermore, a washer 5 is mounted around the first cylindrical post 312 of the first joint member 31. One side of the washer 5 abuts against each attachment arm 11 and each connecting arm 21; another side of the washer 5 abuts against an inner side of the second flange 321 of the second joint member 32 so as to prevent the inner disc 1 and the outer annular disc 2 from being collided with the second joint member 32 (as shown in FIG. 2 and FIGS. 6-7).

Although the invention has been explained in relation to its preferred embodiment, it is to be understood that many other possible modifications and variations can be made without departing from the scope of the invention as hereinafter claimed.

What is claimed is:

1. A bicycle brake disc assembly comprising:
an inner disc having a plurality of attachment arms radially extending from an outer periphery thereof, each of the attachment arms having a first connecting recess defined at a terminal end thereof;
an outer annular disc enclosing the inner disc, the outer annular disc having a plurality of connecting arms extending from an inner periphery thereof toward the inner disc, each of the connecting arms having a second connecting recess defined at a terminal end thereof, the first connecting recess and the second connecting recess defining a connecting hole; and
a plurality of joint assemblies assembled in the connecting hole, each joint assembly having a first joint member and a second joint member, the first joint member having a first flange defined at one end thereof and a first cylindrical post protruded from one side of the first flange, the first joint member having a through hole opened therethrough, the second joint member having a second flange defined at one end thereof and a second cylindrical post protruded from one side of the second flange, the second cylindrical post having a bending portion defined at a terminal end thereof, the second cylindrical post passing through the through hole of the first joint member, a buffer groove defined between the first flange and the second flange, the terminal end of each attachment arm and the terminal end of each connecting arm clipped in the buffer groove so that the inner disc and the outer annular disc are movable within the buffer groove of each joint assembly.

2. The bicycle brake disc assembly as claimed in claim 1, wherein the first joint member of each joint assembly has a shoulder defined in an inner periphery of the through hole; the bending portion of the second joint member passes through the through hole and is further bent toward the shoulder and abutted against the shoulder.

3. The bicycle brake disc assembly as claimed in claim 1, wherein the connecting hole has a large aperture and a small aperture defined therein, the large aperture communicating with the small aperture; the first cylindrical post of the first joint member passes through the small aperture and the first flange is positioned in the large aperture.

4. The bicycle brake disc assembly as claimed in claim 2, further comprising a washer mounted around the first cylindrical post of the first joint member; one side of the washer abuts against each attachment arm and each connecting arm; another side of the washer abuts against an inner side of the second flange of the second joint member.
